(19) United States
(12) Patent Application Publication
(10) Pub. No.: US 2014/0020558 A1
(43) Pub. Date: Jan. 23, 2014

(54) APPARATUS AND METHOD FOR REMOVAL OF PARTICULATE MATTER FROM A GAS

(71) Applicants: Sridhar Gururaja Rao, Bangalore (IN); Thomas Hammer, Hemhofen (DE); Amit Kumar Singh Parihar, Satna (IN)

(72) Inventors: Sridhar Gururaja Rao, Bangalore (IN); Thomas Hammer, Hemhofen (DE); Amit Kumar Singh Parihar, Satna (IN)

(21) Appl. No.: 13/979,192

(22) PCT Filed: Nov. 16, 2011
(86) PCT No.: PCT/EP2011/070251

§ 371 Date: Sep. 26, 2013

(30) Foreign Application Priority Data
Jan. 11, 2011 (IN) 32/KOL/2011

(51) Int. Cl. B03C 3/011

(52) U.S. Cl. CPC B03C 3/011
USPC 95/69; 96/57

(57) ABSTRACT

An apparatus and method remove particulate matter from a gas. The apparatus has an inlet for receiving a contaminated gas having particulate matter, and for inducing a swirl to the contaminated gas. A cyclonic separation stage including a first flow-path is provided for separating a portion of the particulate matter from the swirl-induced contaminated gas by centrifugal action, to produce a partially clean gas. An ionization stage including a second flow-path is provided for ionizing the particulate matter remaining in the partially clean gas by producing a corona discharge in the second flow-path. A particle collection stage including a third flow-path is provided for separating the ionized particulate matter from the gas using an electric field across the third flow-path, to produce a clean gas. The ionization stage and the particle collection stage are arranged such that the third flow-path has an increased cross-sectional area relative to the second flow-path.

### CROSS REFERENCE TO RELATED APPLICATIONS

This application is based on and hereby claims priority to International Application No. PCT/EP2011/070251 filed on Nov. 16, 2011 and Indian Application No. 32/KOL/2011 filed on Jan. 11, 2011, the contents of which are hereby incorporated by reference.

### BACKGROUND

The present invention relates to removal of particulate matter from a gas, and in particular.

Fuel and flue gas generated from the thermo-chemical conversion processes mostly contain dust particles having a wide range of sizes. These gases should be free of dust particles either to meet the end application or to meet the environmental norms.

Cyclone separators are well-known devices for removing particulates from a gas stream. In principle, a stream of particle-laden raw gas is introduced tangentially into a cyclonic separation zone so that the particles experience a centrifugal force in the ensuing swirling flow. The particles are collected on the outer wall of the separation zone and a resultant clean gas exits from a central exhaust duct. Cyclones are considered suitable for removing particles larger than 10 μm from a gas stream due to centrifugal force, which is responsible for particle separation. However, their low collection efficiency with respect to separation of particles smaller than 5 to 10 μm puts an additional requirement for further cleaning of the gas to the desired levels. Conceptually, cyclones can be designed to remove sub-micron particles but the associated pressure drop would be prohibitively high resulting considerable power consumption. Also, depending on the extent of dust loading i.e. concentration of dust particles, there is a possibility of choking at the entry of the cyclone. Hence, the best cyclone design is essentially a trade-off between performance i.e. collection efficiency and the allowable pressure drop.

To make a gas free of particulate matter, a series of pollution control equipment including cyclone, scrubbers, electrostatic precipitators (ESP) are generally employed. In this arrangement, the cyclone removes the larger particles from the gas to reduce load on the subsequent equipment like scrubber, ESP and filters where removal of the smaller particles takes place.

Due to strict environmental regulations, most of the industrial applications use dust filters, such as woven textile bag filter, or ceramic candle filter, to remove dust particles. However, the pressure drop across the filter, and problems related to the regeneration of filter, make this technology less attractive compared to other available options. Electrostatic precipitators are considered very effective in removal of smaller particles because of dominancy of electrical forces and have been used mainly in thermal power plants for fly ash removal. Pressure drop across an ESP is significantly lower than for any other pollution control equipment. Thus the resulting energy consumption is lower making the ESP a favorable option.

U.S. Pat. No. 4,352,681 discloses a combination of cyclone and electrostatic precipitator to improve the collection efficiency of the cyclone. In this arrangement, charging and collection of particle due to electrostatic separation and separation due to centrifugal action happens simultaneously inside cyclone. Unfortunately, the above disclosed type of hybrid apparatus for particle removal does not result in substantially increased particle collection efficiency because of several reasons. The first reason is that the disclosed apparatus provides inefficient particle charging, which is attributed to the fact that a large number of particles (especially of large sized particles) compete for electrical charges. The second reason is that low residence time inside of the cyclone results in poor efficiency of electrostatic assistance of particle collection.

### SUMMARY

One potential object is to improve the particle separation/collection efficiency of a hybrid particle removal apparatus involving a cyclone separator and an electrostatic separator.

The inventors propose combining a cyclonic separation with two stage electrostatic precipitation, to increase the overall collection efficiency by stepwise removal of particulate matter in a gas. Cyclonic separation is effective for removal of larger particles due to larger centrifugal force acting on the particles, while electrostatic precipitation is effective in removal of smaller particles because of dominancy of electrical forces. An important feature is to carry out electrostatic precipitation in two separate stages, namely, an ionization or particle charging stage, and a particle collection stage. In the proposed arrangement, the ionization stage has a higher flow cross-section than the particle collection stage. In this way, gas velocity is kept higher in the ionization stage to provide enhanced particle charging. On the other hand, gas velocities in the collection stage is kept lower to provide enough residence time for the ionized particles to get separated from the gas stream. The particle collection stage provides an electrical field across the flow-path to promote the separation and migration of the ionized particles.

The proposed technique of carrying out particle charging and particle collection in two separate stages provides significantly improved particle separation/collection efficiency with respect to the existing related art that includes single stage electrostatic precipitators.

In one proposed embodiment,
the ionization stage comprises a radially inwardly disposed ionization duct in flow communication with the cyclonic separation stage and a first portion of an electrode disposed substantially coxially inside the ionization duct, wherein the corona discharge is produced by applying a corona initiation voltage across the electrode and the ionization duct, and
the particle collection stage comprises an electrically grounded collection duct disposed substantially coxially around a second portion of the electrode extending out of the ionization duct, wherein the ionized particulate matter is separated by an electric field between the second portion of the electrode and the collection duct, the collection duct having an increased cross-sectional area relative to the ionization duct.

Advantageously, the above embodiment does not require any additional chamber for particle charging or ionization. The vortex finder duct of the cyclone is used as the ionization duct for particle charging. So, during normal cyclone operation when partially clean gas passes through this vortex finder duct, particles get charged. For particle collection, a separate duct (of higher flow cross-section) is arranged coaxially over the vortex finder duct.

In one embodiment, for facilitating corona discharge, the first portion of the electrode comprises a rod whose cross-section includes one or more sharp edges.

In an exemplary embodiment, the first portion of the electrode comprises a rod and a plurality of sharp-edged disks along the length of the rod. Advantageously, the above kind of electrode structure reduces the corona initiation voltage. This may be further advantageous in reducing electrical insulation problems at the voltage feed-through.

In an alternate embodiment, the first portion of the electrode comprises a rod having a single sharp-edged disk located at the first portion of the electrode. Advantageously, this provides concentration of ion current to a small region which results in increase of electric field and charge density, thus increasing the particle charging efficiency.

In a further embodiment, the proposed apparatus further comprises an insulated feed-through arrangement for passing the corona initiation voltage to the electrode.

In one example embodiment, the collection duct has a variable cross-sectional area that increases in the direction of flow along the third flow-path, and wherein the dimensions of electrode are configured such that the gap between collection duct and the second portion of the electrode is constant in the direction of flow along the third flow-path. Advantageously, this embodiment provides further increase in efficiency of charging and precipitation of ultrafine particles in the size range <200 nm and further advantageously incurs a lower voltage requirement.

In an alternate embodiment, wherein the dimensions of the first portion of the electrode are configured such that the gap between ionization duct and the first portion of the electrode increases in the direction of flow along the second flow-path. Advantageously, this embodiment leads to a reduction in the fraction of ionization current flowing in the second portion of the electrode without compromising collection efficiency.

In a further embodiment, the second portion of the electrode is covered by a metallic mesh. Advantageously, this embodiment provides a homogenous electric field in the particle collection stage such that no corona discharge initiation takes place at the particle collection stage. This ensures that no particle charging but only particle collection takes place at this stage. This configuration also reduces electric power requirements.

In a still further embodiment, the proposed apparatus further comprises an arrangement for cooling the feed-through arrangement.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a schematic diagram of an apparatus for removal of particulate matter from a gas,

FIG. 2 illustrates an exemplary embodiment of an apparatus having a double-shell construction to aid particle collection,

FIG. 3 illustrates an exemplary embodiment of an apparatus wherein the electrode comprises several sharp-edged disks to aid corona discharge initiation,

FIG. 4 illustrates an exemplary embodiment of an apparatus, wherein the collection stage has increased flow cross-section with constant electrode gap,

FIG. 5 illustrates an exemplary embodiment of an apparatus, wherein a metallic mesh is disposed around the second portion of the electrode,

FIG. 6 illustrates an exemplary embodiment of an apparatus wherein the first portion of the electrode comprises a single sharp-edged disk,

FIGS. 7a-b respectively illustrate an elevation view and plan view of a cyclone showing the dimensions used for calculation,

FIG. 8 is a graph depicting the variation of particle migration velocity with particle diameter for a wire tube type and a disk tube type electrostatic precipitator, and

FIG. 9 is a graph depicting the variation of particle migration velocity with particle diameter for a wire tube type and a disk tube type electrostatic precipitator.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

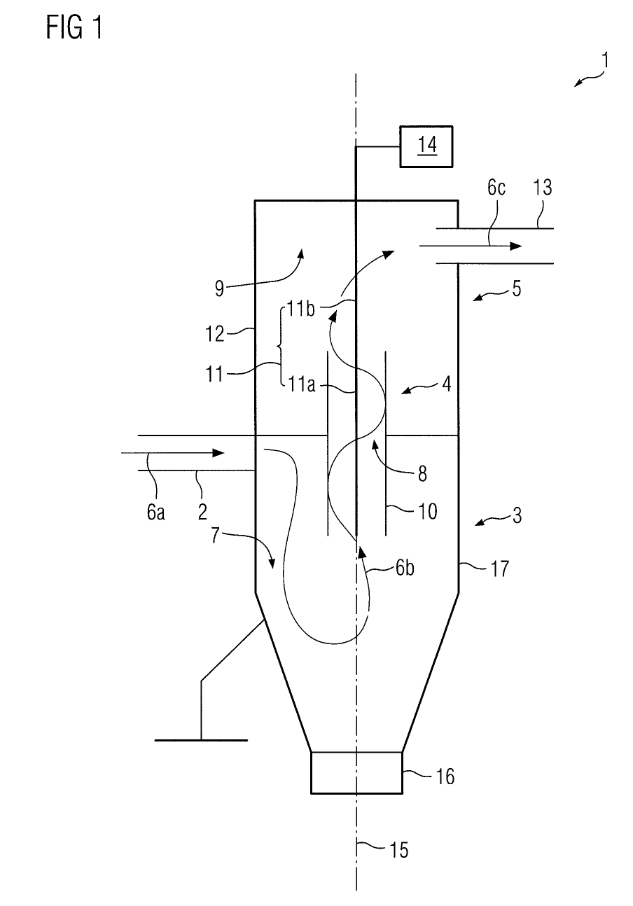

Referring now to FIG. 1 is illustrated an apparatus 1 for removal of particulate matter from a gas according to an exemplary embodiment of the proposed device. The illustrated apparatus 1 provides a compact solution combining a cyclone with two-stage electrostatic precipitator to increase the overall particle collection efficiency by stepwise removal of particulate matter. The apparatus 1 includes an inlet 2 for receiving a contaminated gas 6a that comprises particulate matter. The gas 6a to be cleaned may include a hot gas, such as an industrial flue gas, or a fuel gas, such as producer gas. The particulate matter contained in the contaminated gas 6a may include, for example ash and dust particles in a wide range of sizes, including large sized particles (>10 μm), intermediate sized particles (>1 μm) and small sized particles (sub-micron).

The inlet 2 is designed to induce a swirl to the incoming particle-laden gas 6a as it is introduced tangentially to a cyclonic separation stage 3 (also referred to simply as “cyclone”). The cyclone 3 is disposed about an axis 15 and includes a flow-path 7. The swirl imparted to the gas 6a tends to concentrate the particulate matter, particularly large sized particles towards the outer wall 17 of the cyclone by centrifugal action, to produce a resultant partially clean gas 6b. The particulate matter that concentrates on the outer wall 17 of the cyclone may be removed, for example by rapping on the outer wall 17 and collected in a particle collection box 16. The partially clean gas 6b reverses its flow direction to exit the cyclone 3. While the cyclone 3 is effective for removing large sized particles, smaller and intermediate sized particles would experience lesser centrifugal force and therefore would remain with partially clean gas 6b. Removal of such remaining small and intermediate sized particulate matter from the partially clean gas 6b is carried out by two-stage electrostatic precipitation comprising a particle charging or ionization stage 4 and a particle collection stage 5, as illustrated below.

The ionization stage 4 is formed by a radially inwardly disposed ionization duct 10, also known as a vortex finder duct, disposed in the flow-path of the gas 6b exiting the cyclone. The ionization stage 4 includes a flow-path 8 formed by the duct 10 and further comprises a mechanism for producing a corona discharge in the flow-path 8 for charging or ionizing the particulate matter remaining in the partially clean gas 6b. To achieve this, an electrode 11 is disposed substantially coaxially with respect to the ionization duct 10, such that a first portion 11a of the electrode is within the ionization duct. The electrode 11 is connected to a high-voltage source, preferably of negative polarity, which is capable of producing a corona initiation voltage between the first portion 11a of the electrode and the ionization duct 10. As a result of the voltage applied between the ionization duct and the first portion 11a of the electrode, a corona discharge is produced in the flow-path 8 that ionizes the remaining particulate matter in the gas flowing through it. The electrode 11 may comprise a metallic rod having sharp edges, particularly at the location of the first portion 11a, to aid in the production of a corona discharge. Advantageously, the cross-sectional area of the flow-path 8, i.e., of the ionization duct 10 is designed to be sufficiently small such that the gas flowing therethrough has a high velocity (i.e., high energy), which, in turn increases the particle charging efficiency and reduces the possibility of particle collection within the ionization duct 10. In order to prevent particle collection in the ionization duct 10, a negative potential may be further applied to the ionization duct 10. Based on the charging requirement, the length of the ionization duct 10 and number of corona discharge producing electrodes can be varied to achieve best performance.

The gas flowing out of the ionization stage 4 thus comprises charged or ionized particulate matter. This charged or ionized particulate matter is separated from the gas subsequently at the particle collection stage 5. At the particle collection stage 5, the velocity of the gas is suitably reduced in order to provide enough residence time for particle separation. Accordingly, the particle collection stage 5 has a flow-path 9 whose cross-sectional area is increased relative to that of the flow-path 8. The separation of charged or ionized particles from the gas is effected by an electric field in the flow-path 9. In the illustrated embodiment, the particle collection stage 5 includes a collection duct 12 disposed coaxially with respect to the ionization duct 10, but having an increased cross-sectional area. The collection duct 12 surrounds a second portion 11b of the electrode that extends out of the ionization duct 10. The collection duct 12 is electrically grounded. An electric field is produced in the flow-path 9 due to the voltage applied between the second portion 11b of the electrode and the collection duct 12. This electric field causes migration of charged or ionized particles towards grounded collection duct. Once the charged particles are deposited at the collection duct 12 they may be removed either using some impulse/force in case of a dry system or liquid such as water in the case of a wet system. Since the velocity of particles in the ionization duct 10 is high, the deposition particles in the ionization duct 10 would be comparatively low and this can be cleaned by using some rapping mechanism at the end of operation.

The gas 6c flowing out of the particle collection stage 5 is thus a clean gas, substantially free of particulate matter, which exits the apparatus 1 through an outlet 13.

The feature of the apparatus 1 is thus to implement electrostatic precipitation in two separate stages, namely ionization and particle collection. This allows the gas velocity to be kept high at the ionization stage 4, which significantly increases the particle charging efficiency, while the gas velocity is kept low at the particle collection stage 5 to provide sufficient residence time for increased particle collection efficiency. The overall separation/collection efficiency is thereby increased in comparison to a single stage electrostatic precipitator (ESP). Further, the use of the cyclone 3 ensures that only small or intermediate sized particles need to be charged at the ionization stage, which advantageously incurs lower power requirements, thereby increasing charging efficiency.

Thus, in summary, in the arrangement disclosed in the illustrated embodiment, charging efficiency of particles in general and especially of small particles is improved due to (a) reduced number of particles to be charged, (b) lower number of large sized particles, which could be charged more easily, (c) reduced space charge effects in the ionization stage, and (d) increased ion density in the ionization stage for the same ESP current resulting in faster charging.

In most of the dry ESPs being currently used for fly ash removal, a dust conditioning chemical is mixed with gas before sending it to the ESP, mainly to avoid dust resistivity problem. In the proposal, this chemical can be added in the cyclone to provide better mixing of chemical with dust due to the existing vortex flow in the cyclone.

Further advantageously, the arrangement disclosed can be used for hot gas cleaning, which eliminates the need to install any other clean-up system. In particular, the apparatus is very useful of cleaning the producer gas. This is because in a conventional arrangement, tar present in the producer gas might condense on to the insulators (used to provide alignment to the discharge electrode) in the ESP. This deposition of tar on the insulator can result into corona collapse due to short circuiting of current. However, since the apparatus may be used for hot gas cleaning, the tar present in the producer gas will not condense on to the insulator and will not hinder the ESP operation.

The apparatus also provides a compact design that presents a solution to challenges related to the space and gas flow ducting and associated pressure drop faced by convention particulate control systems.

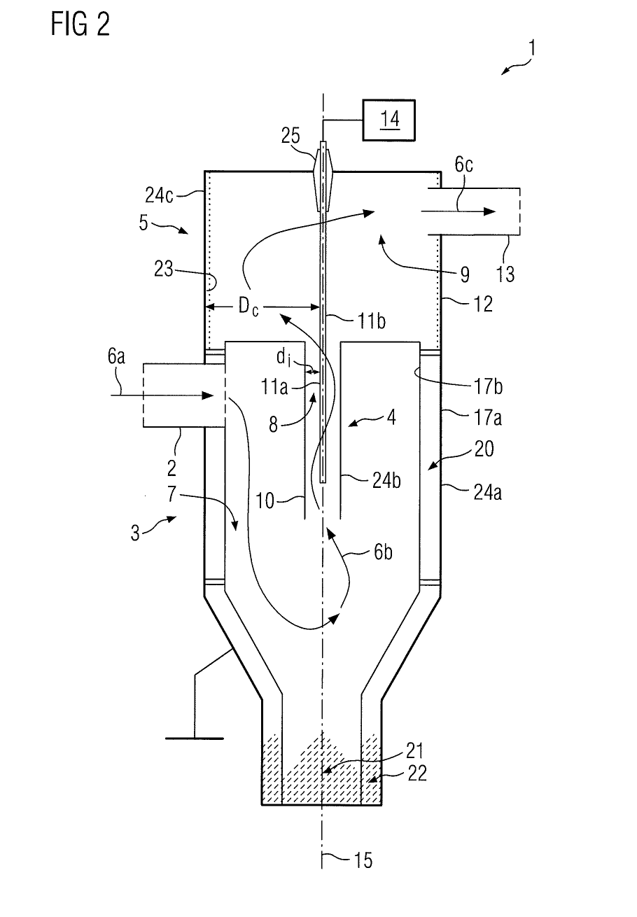

Several advantageous embodiments of the proposal may be considered, as illustrated referring to FIGS. 2-6, wherein like reference signs refer to like elements.

In the embodiment shown in FIG. 2 the apparatus 1 has a double-shell construction including an outer wall 17a and an inner wall 17b separated by an annular gap 20. The small and intermediate size particles 23 that are deposited at the collection duct 12 are removed, for example, by rapping (at location 24c), via the gap 20 to a fine particle outlet 22. Larger particles, separated at the cyclone separation stage 3 concentrate at the inner wall 17b from which they are removed, for example, by rapping (at location 24a), to a coarse particle outlet 21. Some amount of particle collection may also possibly take place within the ionization duct 10. Such particles may be removed by rapping (at location 24b) into the outlet 21. The advantage of the illustrated double-shell construction is that it leads to reduced heat loss which prevents condensation of tar. 1. The same arrangement can be further modified to the wet type ESP in which water or any other liquid can be used to drain out particles deposited on the grounded collection duct 12.

The electrode 11 in this case includes an electrode rod whose cross-section has sharp edges, for example a rectangular or polygonal or star shaped cross-section. The corona initiation voltage is applied by a high-voltage power source 14 via an insulated feed-through arrangement 25. The sharp edges of the electrode facilitate production of corona discharge at the ionization stage 4. The gap between the first portion 11a of the electrode and the ionization duct 10 is indicated as dᵢ (also referred to as discharge gap) while gap between the second portion 11b of the electrode and the collection duct 12 is indicated as D_{C}. In the embodiment of FIG. 2, both dᵢ and D_{C} are constant.

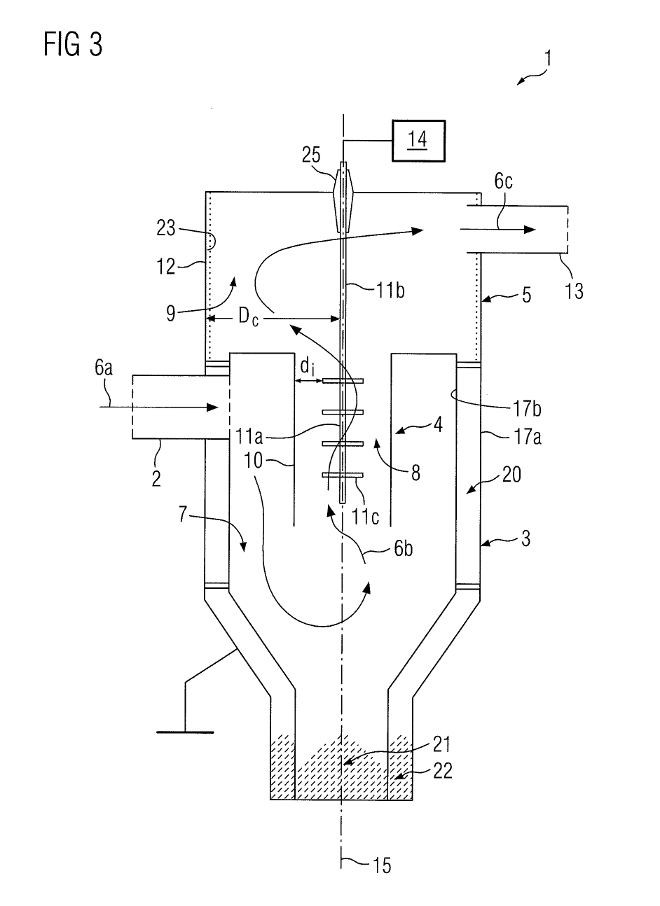

In the embodiment illustrated in FIG. 3, the first portion 11a of the electrode comprises additional structures including a plurality of disks 11c having sharp edges along the length of the electrode rod. Advantageously, these additional structures reduce the corona initiation voltage required. Further advantageously, these structures reduce electrical insulation problems at the high-voltage feed-through arrangement 25, for example by reducing the risk of dielectric breakdown of the high voltage feed-through insulator. Further, design parameters of ionization stage 4 inside the duct 10 may be chosen such that intermediate size particles (1 μm<d<10 μm) are not only charged but also collected in the ionization stage 4. This has the advantage that in the upper (downstream) part of this stage more efficient charging of small particles (d<1 μm) is achieved.

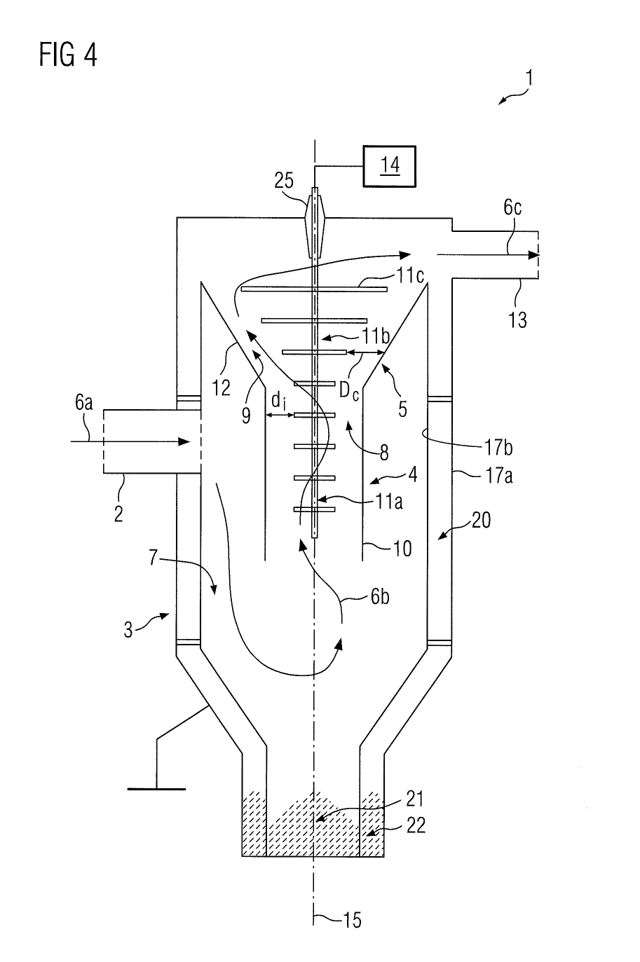

In the embodiment illustrated in FIG. 4 the cross-sectional area of the flow-path 9 in the particle collection stage 5 is variable such that it increases in the direction of flow along the flow-path 9. Thus herein, the collection duct 12 is of conical shape. However, the electrode dimensions in the second portion 11b are configured such that the electrode gap D_{C} is constant. This may be achieved, for example, by providing disks 11c having increasing diameters along the length of the second portion of the electrode 11b. Increasing flow cross-section while maintaining a constant electrode gap D_{C} provides more efficient charging and precipitation of ultrafine particles (in the size range <200 nm) and further results in lower voltage requirement. Further, such additional electrode structures (like disks 11c) at the particle collection stage 5 result in an increased electric field at the particle collection stage 5, which, in turn, provides reduced pressure drop, improved collection efficiency and easier removal of collected particles.

In an alternate embodiment (not shown), the electrode dimensions of the first portion 11a may be configured such that the discharge gap dᵢ increases gradually in the direction of flow in the flow-path 8 at the ionization stage 4. This arrangement reduces the fraction of ionization current flowing in the electrode without compromising collection efficiency.

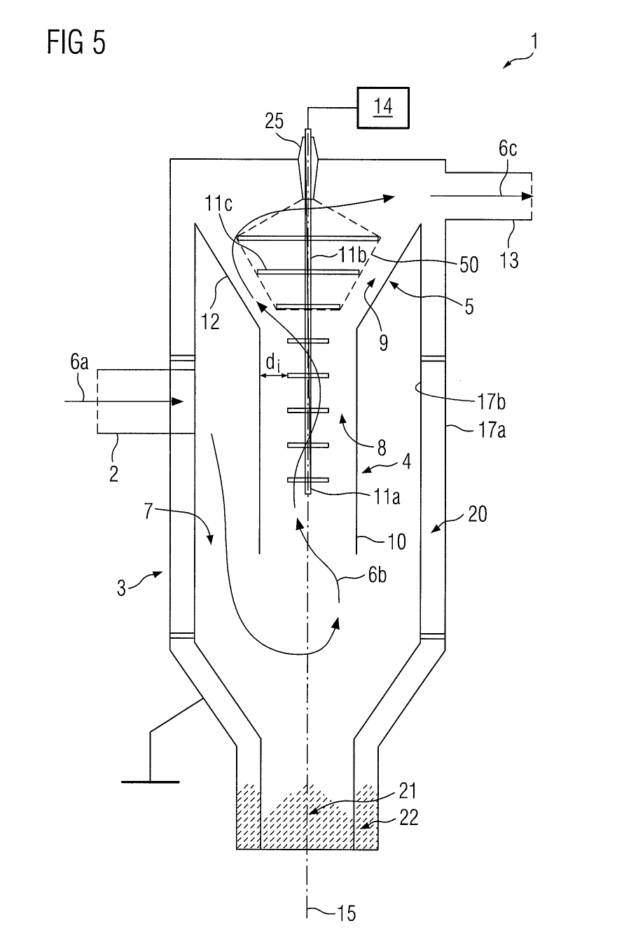

In the embodiment illustrated in FIG. 5, the second portion 11b of the electrode inside the particle collection duct 12 is covered by a metallic mesh 50. By this arrangement, the electric field in the particle collection stage 5 is homogenized, which prevents corona discharge from taking place at the particle collection stage 5, thus ensuring that only particle collection takes place at this stage. The above arrangement also reduces current requirements for particle collection.

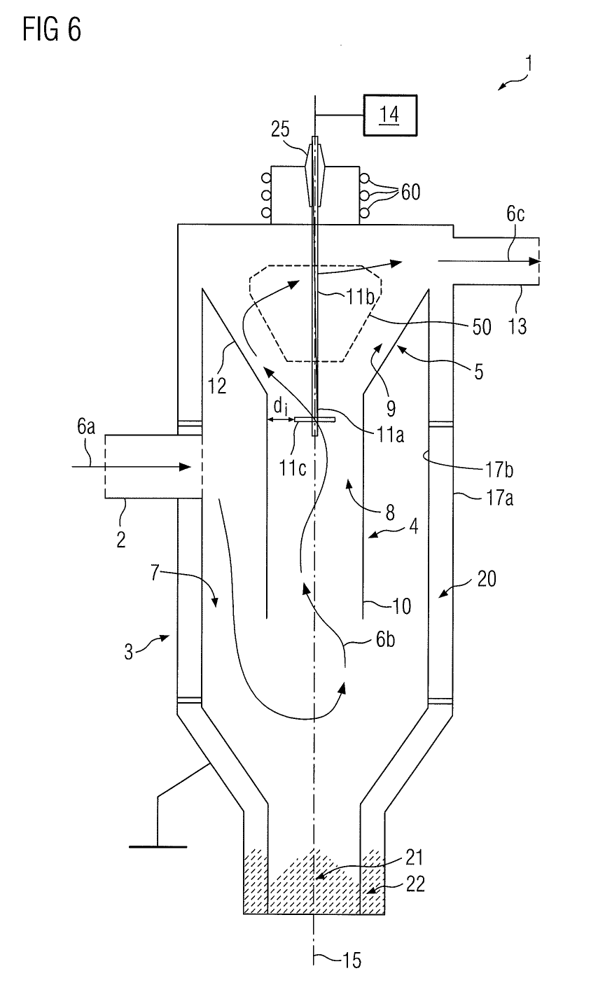

In the embodiment illustrated in FIG. 6, only a single sharp-edged disk 11c is provided on the first portion 11a of the electrode rod at the ionization stage 4. By this arrangement, concentration of ion current to small region results in increase of electric field and charge density at the ionization stage 4, thereby increasing particle charging efficiency. Furthermore, the temperature load of the high-voltage feed-through arrangement 25 may be reduced by disposing the feed-through arrangement 25 in a cooling chamber, for example, having a mechanism 60 for water cooling.

Example Calculations

In order to estimate the collection efficiency of the ESP in this the proposed arrangement, the following cyclone dimensions have been considered as shown in table 1 below:

TABLE 1

| | Symbols | Dimensions (mm) |
|---|---|---|
| Body Diameter | D | 200 |
| Inlet height | a | 100 |
| Inlet width | b | 40 |
| Outlet Diameter | De | 100 |
| Length of Vortex | S | 150 |
| Cylinder height | h | 300 |
| Cone Height | Zc | 500 |
| Dust outlet diameter | B | 75 |
| Overall height | H | 800 |

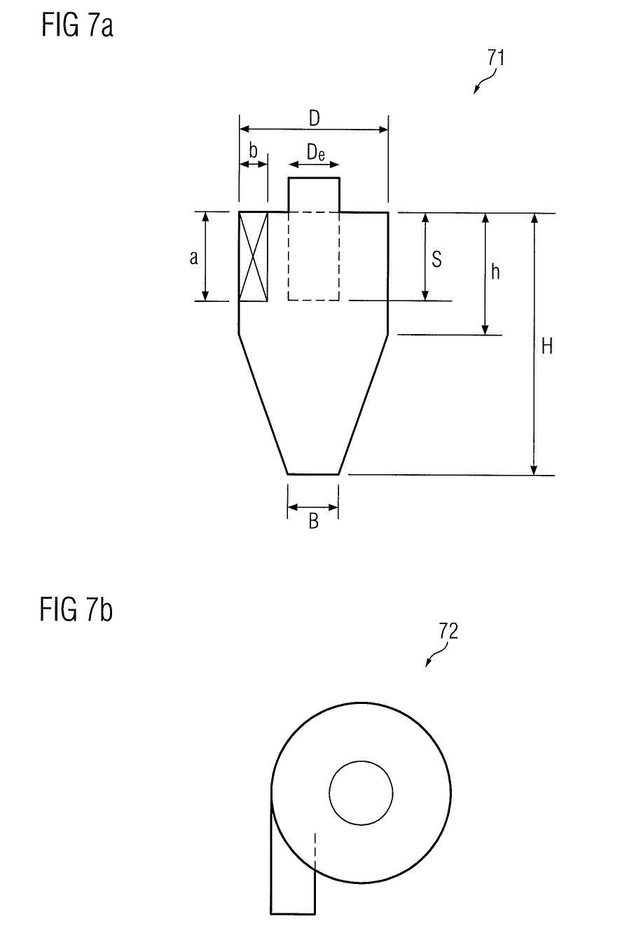

FIG. 7a shows an elevation view 71 of the proposed arrangement illustrating the symbols/notations used for representing the various cyclone dimensions that are included in table 1. FIG. 7b shows a plan view 72 of the proposed arrangement.

Also, for the calculations, the following operating conditions for cyclone at 100% loading Conditions have been considered, namely a cyclone operational temperature of 500° C. and a gas flow rate of 93.24 kg/hr at ambient temperature.

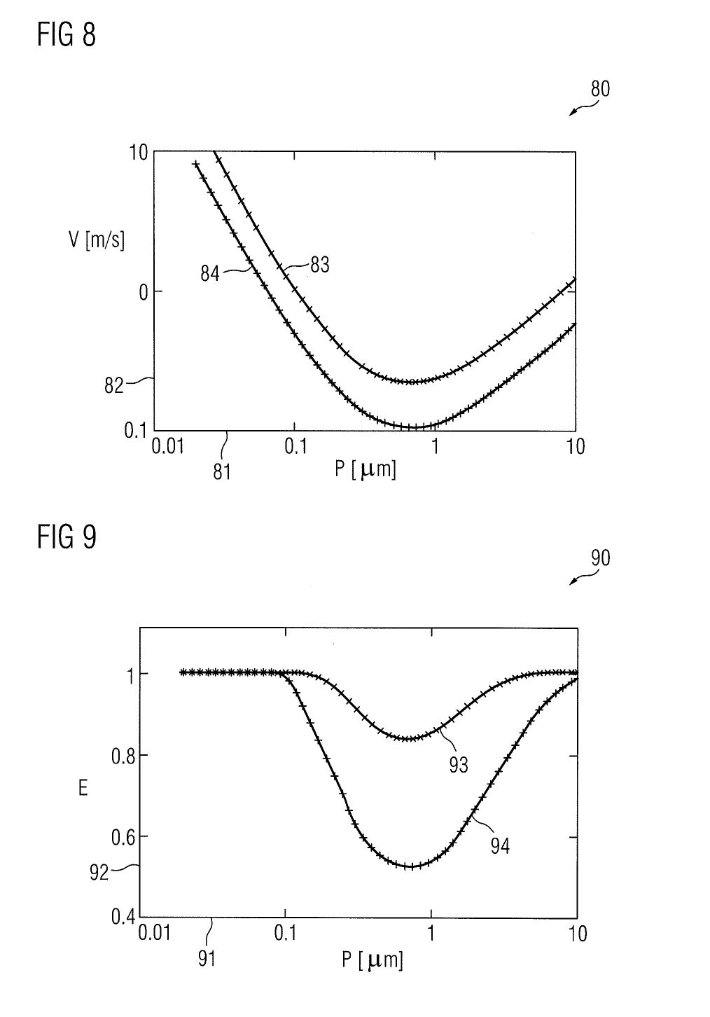

FIG. 8 shows a graph 80 depicting particle migration velocity V [m/s] represented along axis 82 with particle diameter P [μm] represented along the axis 81. The curve 83 depicts this variation as computed for a disk tube type ESP (as illustrated in FIGS. 2, 3 and 6) while the curve 84 depicts this variation as computed for a wire tube type ESP. FIG. 9 shows a graph 90 depicting particle collection efficiency E represented along axis 92 with particle diameter P [μm] represented along the axis 91. The curve 93 depicts this variation as computed for a disk tube type ESP while the curve 94 depicts this variation as computed for a wire tube type ESP. From FIG. 9 it can be easily calculated that disk tube configuration have better collection efficiency over the wire tube type and more so this efficiency is high for finer particles i.e. particles smaller than 10 μm which are difficult to remove using cyclone.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. (canceled)

2-13. (canceled)

14. An apparatus for removal, comprising:
an inlet to receive a contaminated gas comprising particulate matter, to induce a swirl to the contaminated gas and to form a swirl-induced contaminated gas,
a cyclonic separation stage including a first flow-path and arranged to separate a portion of the particulate matter from the swirl-induced contaminated gas by centrifugal action, to produce a partially clean gas,
an ionization stage including a second flow-path and arranged to ionize the particulate matter remaining in the partially clean gas and form ionized particulate matter by producing a corona discharge in the second flow-path, and
a particle collection stage including a third flow-path and arranged to separate the ionized particulate matter from the partially clean gas using an electric field across the third flow-path, to produce a clean gas,
wherein the ionization stage and the particle collection stage are arranged such that the third flow-path has a greater cross-sectional area relative to the second flow-path.

15. The apparatus according to claim 14, wherein
the apparatus comprises an electrode having first and second portions,
the ionization stage comprises a radially inwardly disposed ionization duct in flow communication with the cyclonic separation stage,
the first portion of the electrode is disposed substantially coxially inside the ionization duct,
the corona discharge is produced by applying a corona initiation voltage across the electrode and the ionization duct,
the second portion of the electrode extends out of the ionization duct,
the particle collection stage comprises an electrically grounded collection duct disposed substantially coxially around the second portion of the electrode,
the ionized particulate matter is separated by an electric field between the second portion of the electrode and the collection duct, and
the collection duct has an increased cross-sectional area relative to the ionization duct.

16. The apparatus according to claim 15, wherein the first portion of the electrode comprises a rod whose cross-section includes one or more sharp edges.

17. The apparatus according to claim 15, wherein the first portion of the electrode comprises a rod and a plurality of sharp-edged disks along a length of the rod.

18. The apparatus according to claim 15, wherein the second portion of the electrode comprises a rod and a plurality of sharp-edged disks along a length of the rod.

19. The apparatus according to claim 15, wherein the first portion of the electrode comprises a rod having only a single sharp-edged disk.

20. The apparatus according to claim 15, further comprising an insulated feed-through arrangement to pass the corona initiation voltage to the electrode.

21. The apparatus according to claim 15, wherein
the collection duct has a variable cross-sectional area that increases in a direction of flow along the third flow-path, and
the dimensions of the electrode are configured such that a gap between collection duct and proximate portions of the second portion of the electrode is substantially constant in the direction of flow along the third flow-path.

22. The apparatus according to claim 21, wherein
the second portion of the electrode comprises a rod and a plurality of sharp-edged disks along a length of the rod, and
a gap between collection duct and the sharp-edged disks is substantially constant in the direction of flow along the third flow-path.

23. The apparatus according to claim 15, wherein the first portion of the electrode is dimensioned such that a gap between the ionization duct and proximate portions of the first portion of the electrode increases in a direction of flow along the second flow-path.

24. The apparatus according to claim 23, wherein the first portion of the electrode comprises a rod and a plurality of sharp-edged disks along a length of the rod, and a gap between the collection duct and the sharp-edged disks is substantially constant in the direction of flow along the second flow-path.

25. The apparatus according to claim 15, wherein the second portion of the electrode is covered by a metallic mesh.

26. The apparatus according to claim 18, wherein the second portion of the electrode is covered by a metallic mesh which covers at least a plurality of the sharp-edged disks.

27. The apparatus according to claim 20, further comprising an arrangement to cool the feed-through arrangement.

28. The apparatus according to claim 14, wherein the ionization stage is a single chamber and the apparatus contains no other chamber that ionizes the particulate matter remaining in the partially clean gas.

29. The apparatus according to claim 14, further comprising:
an outer wall; and
an inner wall, surrounded by and separated from the outer wall, surrounding at least a portion of the first flow path.

30. A method for removal, comprising:
receiving a contaminated gas comprising particulate matter, and inducing a swirl to the contaminated gas, to thereby form a swirl-induced contaminated gas,
passing the swirl-induced contaminated gas to a cyclonic separation stage including a first flow-path, to separate a portion of the particulate matter from the swirl-induced contaminated gas by centrifugal action, to produce a partially clean gas,
passing the partially clean gas to an ionization stage including a second flow-path, to ionize the particulate matter remaining in the partially clean gas and to form a gas comprising ionized particulate matter by producing a corona discharge in the second flow-path, and
passing the gas comprising ionized particulate matter to a particle collection stage including a third flow-path, to separate the ionized particulate matter using an electric field across the third flow-path, to thereby produce a clean gas,
wherein the ionization stage and the particle collection stage are arranged such that the third flow-path has an increased cross-sectional area relative to the second flow-path.

31. The method according to claim 30, wherein
the apparatus comprises an electrode having first and second portions,
the passing the partially clean gas to the ionization stage comprises passing the partially clean gas to a radially inwardly disposed ionization duct in flow communication with the cyclonic separation stage, the ionization duct having the first portion of the electrode disposed substantially coxially therein,
the corona discharge is produced by applying a corona initiation voltage across the electrode and the ionization duct,
the second portion of the electrode extends out of the ionization duct,
the passing the gas comprising ionized particulate matter to the particle collection stage comprises passing the gas comprising ionized particulate matter to an electrically grounded collection duct disposed substantially coxially around the second portion of the electrode extending out of the ionization duct,
the ionized particulate matter is separated using an electric field between the second portion of the electrode and the collection duct, and
the collection duct has an increased cross-sectional area relative to the ionization duct.

32. The method according to claim 30, wherein the contaminated gas is an industrial flue gas or a fuel gas.
